(19) United States
(12) Patent Application Publication
(10) Pub. No.: US 2021/0089932 A1
(43) Pub. Date: Mar. 25, 2021

(54) FORECASTING VALUES UTILIZING TIME SERIES MODELS

(71) Applicant: International Business Machines Corporation, Armonk, NY (US)

(72) Inventors: Si Er Han, Xian (CN); Xiao Ming Ma, Xian (CN); Zhiyuan Wang, Xian (CN); Rui Wang, Xian (CN); Lei Gao, Xian (CN)

(21) Appl. No.: 16/581,836

(22) Filed: Sep. 25, 2019

(51) Int. Cl. G06N 5/02; G06K 9/62

(52) U.S. Cl. CPC G06N 5/022; G06K 9/6256; G06K 9/6232

(57) ABSTRACT

A method, an apparatus and a computer program product for goal seeking analysis are disclosed. In the method, an initial set of first future values of a first variable at a plurality of future time points is obtained. An initial set of second future values of a second variable at the plurality of future time points is obtained. An initial set of third future values of a third variable at the plurality of future time points is obtained. The first variable and the second variable are affected mutually. The third variable is affected by the second variable. Then, the first future values, the second future values and the third future values are adjusted based on a target value of the third variable at a first future time point of the plurality of future time points.

### BACKGROUND

The present invention relates to computer technology, and more specifically, to a method, an apparatus, and a computer program product for forecasting values utilizing time series models.

Nowadays, many business issues may be analyzed by mathematical models. For example, a time series model may be used to forecast one or more values of a target metric in the future, for some individuals or entities (referred to as “users” hereinafter). The time series forecasting of the target metric takes the past values of the target metric and a direct effect into account. Taken the target metric being sales and the direct effect being an advertisement visiting amount on the internet (referred to as “internet advertisement” hereinafter) as an example. The users may record historical time series values of sales and internet advertisement. Then they may forecast, by using the time series model, future values of sales based on the recorded historical values of sales as well as internet advertisement.

It is to be noted that in the context the term “historical value” is taken to specify a determined value prior to the current time point, and the term “past value” is taken to specify a value prior to a given time point at which time series forecasting is taking place. The given time point may be a historical point in time or a future point in time.

### SUMMARY

According to one embodiment of the present invention, there is provided a method. In the method, an initial set of first future values of a first variable at a plurality of future time points is obtained. An initial set of second future values of a second variable at the plurality of future time points is obtained. An initial set of third future values of a third variable at the plurality of future time points is obtained. The first variable and the second variable are affected mutually. The third variable is affected by the second variable. Then, the first future values, the second future values and the third future values are adjusted based on a target value of the third variable at a first future time point of the plurality of future time points.

According to another embodiment of the present invention, there is provided an apparatus. The apparatus includes one or more processors, a memory coupled to the one or more processors, and a set of computer program instructions stored in the memory and executed by the one or more processors to implement the method according to the one embodiment of the present invention as described above.

According to still another embodiment of the present invention, there is provided a computer program product. The computer program product includes a computer readable storage medium having program instructions embodied therewith. The program instructions are executable by one or more processors to implement the method according to the one embodiment of the present invention as described above.

### BRIEF DESCRIPTION OF THE SEVERAL VIEWS OF THE DRAWINGS

FIG. 1 depicts a cloud computing node, according to an embodiment of the present invention.

FIG. 2 depicts a cloud computing environment, according to an embodiment of the present invention.

FIG. 3 depicts abstraction model layers, according to an embodiment of the present invention.

FIG. 4 depicts a schematic flowchart of a method for goal seeking analysis, according to an embodiment of the present disclosure.

FIG. 5 depicts an example relationship of variables for goal seeking analysis, according to an embodiment of the present disclosure.

FIG. 6 depicts a schematic flowchart for illustrating an example process of adjusting variables in the method depicted by FIG. 4.

FIG. 7 depicts a schematic flowchart for illustrating another example process of adjusting variables in the method depicted by FIG. 4.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

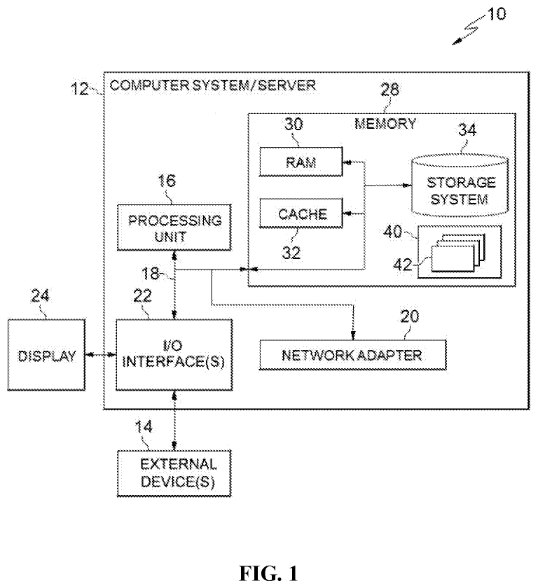

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processing units 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

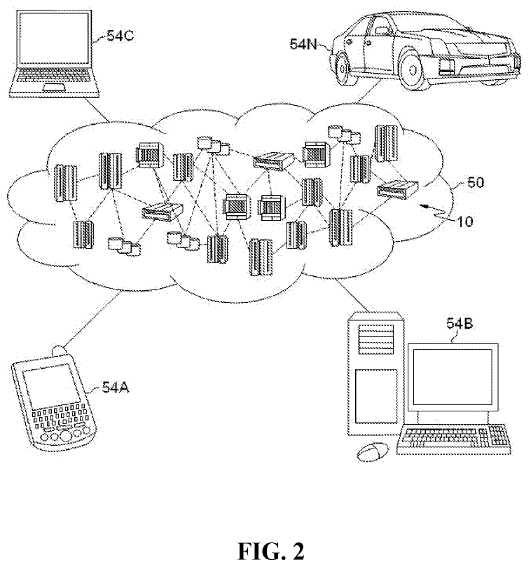

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

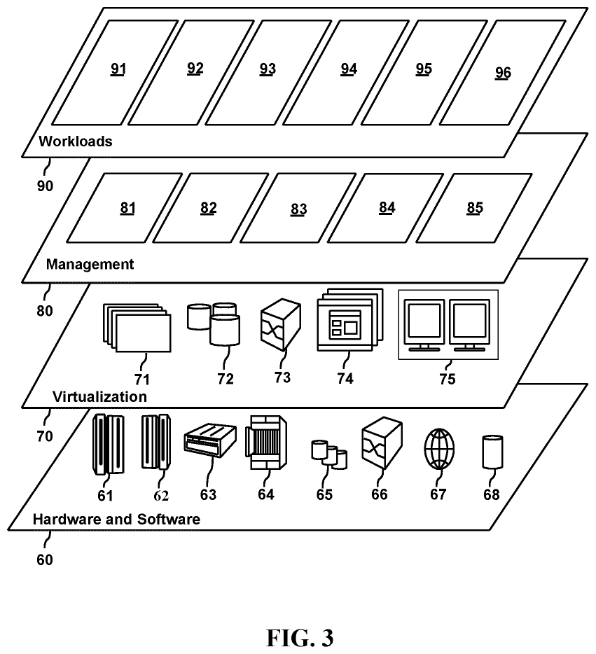

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and goal seeking analysis 96.

In the aforementioned example, the time series model for forecasting the target metric may take the past values of the target metric (e.g., sales) and the direct effect (e.g., internet advertisement) into account. In practice, there are some effects that do not affect the target metric directly. Instead, they affect the target metric by affecting the direct effect. In addition, the direct effect is also affected by them. Such effects are referred to as indirect effects. For example, one indirect effect of sales may be a cost of advertisement on the internet (referred to as “cost” hereinafter).

The present disclosure additionally takes the indirect effect into account for time series forecasting, in order to make the forecasting more practical. In the context, the indirect effect is referred to as a first variable, the direct effect is referred to as a second variable, and the target metric is referred to as a third variable. Therefore, the first variable and the second variable are affected mutually. The third variable is affected by the second variable.

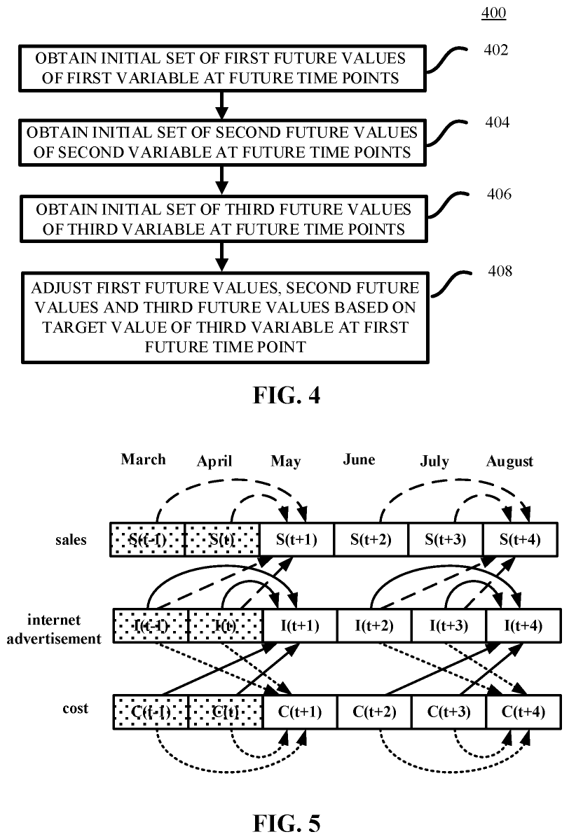

With reference now to FIG. 4, a schematic flowchart of a method 400 for goal seeking analysis according to an embodiment of the present disclosure is illustrated. It should be noted that the processing of goal seeking analysis according to embodiments of this disclosure could be implemented by computer system/server 12 of FIG. 1.

In the method as shown in FIG. 4, at block 402, the computer system/server 12 obtains an initial set of first future values of the first variable (e.g., cost) at a plurality of future time points. In some embodiments, the computer system/server 12 may forecast the initial set of first future values of the first variable at the plurality of future time points by using a first time series model. The first time series model may define that a future value of the first variable is associated with past values of the first variable and the second variable. For example, the first future value at a given future time point may be forecasted based on N past values of the first variable and N past values of the second variable immediately before the given future time point. N is a natural number in the context.

In some alternative embodiments, the computer system/server 12 may receive the initial set of first future values from external apparatus. Therefore, the computer system/server 12 may not know which time series model is used to forecast the initial set of first future values.

At block 404, the computer system/server 12 obtains an initial set of second future values of a second variable (e.g., internet advertisement) at the plurality of future time points. In some embodiments, the computer system/server 12 may forecast the initial set of second future values of the second variable at the plurality of future time points by using a second time series model. The second time series model may define that a future value of the second variable is associated with past values of the first variable and the second variable. For example, the second future value at a given future time point may be forecasted based on N past values of the first variable and N past values of the second variable immediately before the given future time point.

FIG. 5 shows an example relationship of the first, second and third variables, according to an embodiment of the present disclosure. The first variable may be cost. The second variable may be internet advertisement. The third variable may be sales. In FIG. 5, C(t) denotes the value of the first variable at time point t. I(t) denotes the value of the second variable at time point t. S(t) denotes the value of the third variable at time point t. The values in the shaded boxes are historical values. The values in the white boxes are future values.

In the example of FIG. 5, C(t+1) may be forecasted based on C(t−1), C(t), I(t−1), and I(t), by using the first time series model. I(t+1) may be forecasted based on C(t−1), C(t), I(t−1), and I(t), by using the second time series model. For instance, the computer system/server 12 may obtain the values of cost C(t−1), C(t) on March and April, as well as the values of internet advertisement I(t−1), I(t) on March and April, which are all historical values. Then the first future value of cost C(t+1) on May may be forecasted based on C(t−1), C(t), I(t−1), and I(t), by using the first time series model. In this case, the forecasting process answers the question: “what C(t+1) will be, if C(t−1), C(t), I(t−1), and I(t) are known”. The second future value of internet advertisement I(t+1) on May may be forecasted based on C(t−1), C(t), I(t−1), and I(t), by using the second time series model. Here, the forecasting process answers the question: “what I(t+1) will be, if C(t−1), C(t), I(t−1), and I(t) are known”.

From the above, the first future value of cost C(t+1) on May and the second future value of internet advertisement I(t+1) on May may be obtained. Then, similarly, the first future value of cost C(t+2) on June may be forecasted based on C(t), C(t+1), I(t), and I(t+1). The second future value of internet advertisement I(t+2) on June may be forecasted based on C(t), C(t+1), I(t), and I(t+1). Next, the first future value of cost C(t+3) on July may be forecasted based on C(t+1), C(t+2), I(t+1), and I(t+2). The second future value of internet advertisement I(t+3) on July may be forecasted based on C(t+1), C(t+2), I(t+1), and I(t+2). Next, the first future value of cost C(t+4) on August may be forecasted based on C(t+2), C(t+3), I(t+2), and I(t+3). The second future value of internet advertisement I(t+4) on August may be forecasted based on C(t+2), C(t+3), I(t+2), and I(t+3). In this way, the initial set of first future values of the first variable and the initial set of second future values of the second variable are obtained.

In some alternative embodiments, the computer system/server 12 may receive the initial set of second future values from external apparatus. Therefore, the computer system/server 12 may not know which time series model is used to forecast the initial set of second future values.

Turning back to FIG. 4, at block 406, the computer system/server 12 obtains an initial set of third future values of a third variable at the plurality of future time points. In some embodiments, the computer system/server 12 may forecast the initial set of third future values of the third variable at the plurality of future time points by using a third time series model. The third time series model may define that a future value of the third variable is associated with past values of the second variable and the third variable. For example, the third future value at a given future time point may be forecasted based on N past values of the second variable and N past values of the third variable immediately before the given future time point.

Referring to FIG. 5 again, S(t+1) may be forecasted based on I(t−1), I(t), S(t−1), and S(t). For instance, the computer system/server 12 may obtain the values of sales S(t−1), S(t) on March and April, which are both historical values. Then the third future value of sales S(t+1) on May may be forecasted based on I(t−1), I(t), S(t−1), and S(t), by using the third time series model. In this case, the forecasting process answers the question: “what S(t+1) will be, if S(t−1), S(t), I(t−1), and I(t) are known”. Then the third future value of sales S(t+2) on June may be forecasted based on I(t), I(t+1), S(t), and S(t+1). Next, the third future value of sales S(t+3) on July may be forecasted based on I(t+1), I(t+2), S(t+1), and S(t+2). Next, the third future value of sales S(t+4) on August may be forecasted based on I(t+2), I(t+3), S(t+2), and S(t+3).

In some alternative embodiments, the computer system/server 12 may receive the initial set of third future values from external apparatus. Therefore, the computer system/server 12 may not know which time series model is used to forecast the initial set of third future values.

Turning back to FIG. 4 again, at block 408, the first future values, the second future values and the third future values are adjusted based on a target value of the third variable at a first future time point of the plurality of future time points. The target value of the third variable at the first future time point may be set based on the user's expectation. In the example of FIG. 5, for instance, the forecasted third future value of sales S(t+4) on August may be 50 million dollars. But the user hopes it could reach 55 million dollars. In this case, the 55 million dollars is the target value of sales on August, which is referred to as S′(t+4) hereinafter.

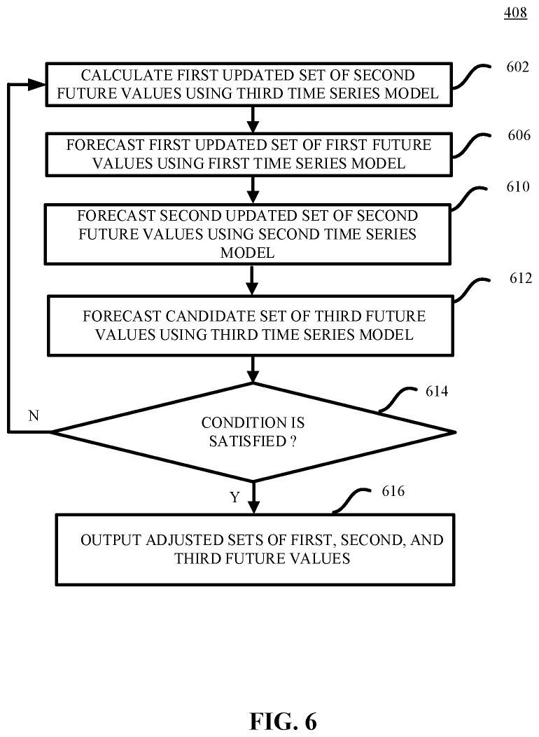

In some embodiments, the first future values, the second future values and the third future values may be adjusted, e.g., with several iterations, using the first time series model, the second time series model and the third time series model. FIG. 6 depicts a schematic flowchart for illustrating an example process of adjusting the first, second and third variables, that is, the action taken at block 408.

At block 602, the computer system/server 12 calculates a first updated set of the second future values using the third time series model, based on the target value of the third variable at the first future time point. In the example of FIG. 5, the first updated set of the second future values is calculated using the third time series model, based on the target value S′(t+4) of sales on August. In some embodiments, based on the target value S′(t+4), the second future values of internet advertisement I(t+2), I(t+3) on June and July may be calculated, by performing goal seeking analysis on the third time series model. In this case, the goal seeking analysis answers the question: “what I(t+2) and I(t+3) will be, if the target value of sales on August is S′(t+4), and the third future values of sales on June and July are S(t+2) and S(t+3)”. Next, the second future value of internet advertisement I(t+1) on May may be calculated based on S(t+1), S(t+2), S(t+3), and the newly calculated I(t+2), by performing goal seeking analysis on the third time series model. Here, S(t+1), S(t+2), and S(t+3) in the first updated set of the third future values are the same as S(t+1), S(t+2), and S(t+3) in the initial set of the third future values. In this case, the goal seeking analysis answers the question: “what I(t+1) will be, if the third future values of sales on May, June and July are S(t+1), S(t+2) and S(t+3), and the second future value of internet advertisement on June is I(t+2)”. In this way, the first updated set of the second future values is obtained.

In some embodiments, the calculation of the first updated set of the second future values is performed in conjunction with an update of the third future values. In the example of FIG. 5, the second future values of internet advertisement I(t+2), I(t+3) on June and July as well as the third future values of sales S(t+2), S(t+3) on June and July may be calculated by performing goal seeking analysis on the third time series model. In this case, the goal seeking analysis answers the question: “what I(t+2), I(t+3), S(t+2), and S(t+3) will be, if the target value of sales on August is S′(t+4)”. Next, the second future value of internet advertisement I(t+1) on May may be calculated based on S(t+1), and the newly calculated S(t+2), S(t+3) and I(t+2), by performing goal seeking analysis on the third time series model. Here, S(t+1) in the first updated set of the third future values is the same as S(t+1) in the initial set of the third future values. In this case, the goal seeking analysis answers the question: “what I(t+1) will be, if the third future values of sales on May, June and July are S(t+1), S(t+2) and S(t+3), and the second future value of internet advertisement on June is I(t+2)”. In this way, the first updated set of the second future values may be obtained.

At block 606, the computer system/server 12 forecasts a first updated set of the first future values using the first time series model, based on the first updated set of the second future values. In the example of FIG. 5, the first future value of cost C(t+1) on May may be forecasted based on C(t−1), C(t), I(t−1), and I(t), by using the first time series model. Here, C(t−1), C(t), I(t−1), and I(t) are all historical values. Then, the first future value of cost C(t+2) on June may be forecasted based on C(t), C(t+1), I(t), and I(t+1), by using the first time series model. Here, C(t+1) is previously calculated. I(t) and C(t) are the historical values. I(t+1) is from the first updated set of the second future values. Next, the first future value of cost C(t+3) on July may be forecasted based on C(t+1), C(t+2), I(t+1), and I(t+2), by using the first time series model. Here, C(t+1) and C(t+2) are previously calculated. I(t+1) and I(t+2) are from the first updated set of the second future values. Then, the first future value of cost C(t+4) on August may be forecasted based on C(t+2), C(t+3), I(t+2), and I(t+3), by using the first time series model. Here, C(t+2) and C(t+3) are previously calculated. I(t+2) and I(t+3) are from the first updated set of the second future values. In this way, the first updated set of the first future values is obtained. In an example, the first updated set of the first future values may not include the first future value of cost C(t+4) on August, since it does not affect the third future value of sales S(t+4) on August.

At block 610, the computer system/server 12 forecasts a second updated set of the second future values using the second time series model, based on the first updated set of the first future values. In the example of FIG. 5, the second future value of internet advertisement I(t+1) on May may be forecasted based on C(t−1), C(t), I(t−1), and I(t), by using the second time series model. Here, C(t−1), C(t), I(t−1) and I(t) are the historical values. Then, the second future value of internet advertisement I(t+2) on June may be forecasted based on C(t), C(t+1), I(t), and I(t+1), by using the second time series model. Here, C(t) and I(t) are the historical values. I(t+1) is previously calculated. C(t+1) is from the first updated set of the second future values. Next, the second future value of internet advertisement I(t+3) on July may be forecasted based on C(t+1), C(t+2), I(t+1), and I(t+2), by using the second time series model. Here, I(t+1) and I(t+2) are previously calculated. C(t+1) and C(t+2) are from the first updated set of the second future values. Then, the second future value of internet advertisement I(t+4) on August may be forecasted based on C(t+2), C(t+3), I(t+2), and I(t+3), by using the second time series model. Here, I(t+2) and I(t+3) are previously calculated. C(t+2) and C(t+3) are from the first updated set of the second future values. In this way, the second updated set of the second future values is obtained. In an example, the second updated set of the second future values may not include the second future value of internet advertisement I(t+4) on August, since it does not affect the third future value of sales S(t+4) on August.

At block 612, the computer system/server 12 forecasts a candidate set of the third future values using the third time series model, based on the second updated set of the second future values. In the example of FIG. 5, the third future value of sales S(t+1) on May may be forecasted based on S(t−1), S(t), I(t−1), and I(t), by using the third time series model. Here, S(t−1), S(t), I(t−1), and I(t) are all historical values. Then, the third future value of sales S(t+2) on June may be forecasted based on S(t), S(t+1), I(t), and I(t+1), by using the third time series model. Here, S(t+1) is previously calculated. I(t) and S(t) are the historical values. I(t+1) is from the second updated set of the second future values. Next, the third future value of sales S(t+3) on July may be forecasted based on S(t+1), S(t+2), I(t+1), and I(t+2), by using the third time series model. Here, S(t+1) and S(t+2) are previously calculated. I(t+1) and I(t+2) are from the second updated set of the second future values. Then, the third future value of sales S(t+4) on August may be forecasted based on S(t+2), S(t+3), I(t+2), and I(t+3), by using the third time series model. Here, S(t+2) and S(t+3) are previously calculated. I(t+2) and I(t+3) are from the second updated set of the second future values. In this way, the candidate set of the third future values is obtained.

At block 614, the computer system/server 12 determines whether a condition is satisfied. The condition includes one of the following items: (a) a first difference between the target value and the third future value at the first future time point in the candidate set of the third future values being lower than a first threshold; (b) a second difference between the first differences at two adjacent iterations being lower than a second threshold; and (c) the times of the iterations being higher than a third threshold. No matter which one of these items is fulfilled, it is determined that the condition is satisfied.

In some embodiments, the computer system/server 12 may determine whether item (a) is satisfied, at first. The computer system/server 12 may obtain the first difference by calculating an absolute value of the target value minus the third future value at the first future time point in the candidate set of the third future values. In the example where the target value of sales on August is 55 million dollars, if S(t+4) in the candidate set of sales is 52 million dollars, the first difference equals to 3 million dollars. Then, the computer system/server 12 determines whether the first difference is lower than the first threshold. In some embodiments, the first threshold may be provided to the computer system/server 12 by the user.

If the first difference is lower than the first threshold, the condition is satisfied (“Y” at block 614), and the process goes to block 616. The computer system/server 12 may output the first updated set of the first future values, the second updated set of the second future values, and the candidate set of the third future values, at block 616. In some embodiments, those values may be displayed on the display 24 as shown in FIG. 1.

If the first difference is not lower than the first threshold, at the first iteration, the process goes back to block 602, to perform the next iteration. Beginning from the second iteration, if the first difference is not lower than the first threshold, the computer system/server 12 may determine whether item (b) is satisfied. The computer system/server 12 may obtain the second difference by calculating an absolute value of the first difference at the current iteration minus the first difference at the iteration immediately before the current iteration.

If the second difference is lower than the second threshold, the condition is satisfied (“Y” at block 614). The computer system/server 12 may consider that no further improvement can be achieved. Therefore, the computer system/server 12 may not perform the next iteration, and then go to block 616. The second threshold may be provided to the computer system/server 12 by the user.

In some embodiments, if the amount of the iterations is higher than the third threshold (item (c)), the condition is satisfied (“Y” at block 614). The computer system/server 12 may not perform the next iteration, and then go to block 616. The third threshold may be provided to the computer system/server 12 by the user.

If none of the three items (a-c) is satisfied, the condition is not satisfied (“N” at block 614). Then the process goes back to block 602, to perform the next iteration. It is appreciated that the condition may include additional items besides items (a-c), such as, a constraint for one or more of the first or second future values being not satisfied. The constraint may be for a single first or second future value at a single time point, may be for a sum of the first future values at several time points, or may be for a sum of the second future values at several time points. The condition is not limited to the aforementioned items, but may include other conceivable conditions.

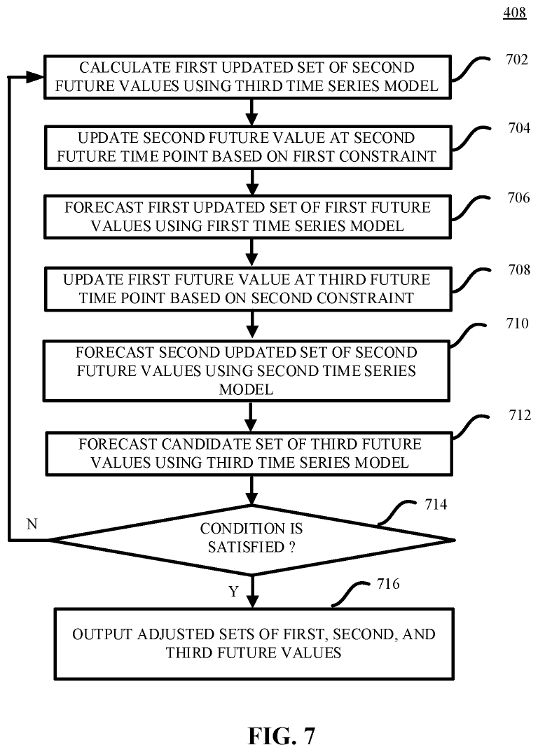

FIG. 7 depicts a schematic flowchart for illustrating another example process of adjusting the first, second and third variables. In this example, the computer system/server 12 considers a first constraint for the second future value at a second future time point and a second constraint for the first future value at a third future time point, if any. The first constraint may define the maximum or minimum value of the second future value at the second future time point. The second constraint may define the maximum or minimum value of the first future value at the third future time point.

At block 702, the computer system/server 12 calculates a first updated set of the second future values using the third time series model, based on the target value of the third variable at the first future time point. The operation at block 702 is the same as the operation at block 602 of FIG. 6.

At block 704, the computer system/server 12 may update the second future value at the second future time point in the first updated set of the second future values based on the first constraint for the second future value at the second future time point, to obtain an amended first updated set of the second future values. In the example of FIG. 5, the second future value of internet advertisement I(t+2) on June could not exceed 100 million times of visiting, due to e.g., statistic observation. In this example, the 100 million times of visiting is the first constraint for internet advertisement on June, which is referred to as I′(t+2) hereinafter.

In this example, if I(t+2) is higher than I′(t+2), the computer system/server 12 replaces I(t+2) in the first updated set of internet advertisement by I′(t+2). Thus, the amended first updated set of internet advertisement is obtained, which is used as the current updated set of internet advertisement. If I(t+2) is not higher than I′(t+2), the amended first updated set of internet advertisement, as the current updated set of internet advertisement, is the same as the first updated set of internet advertisement. It is to be noted that if there is no constraint for the second variable, the amended first updated set of the second future values is the same as the first updated set of the second future values.

At block 706, the computer system/server 12 forecasts a first updated set of the first future values using the first time series model, based on the amended first updated set of the second future values. The operation at block 706 is similar to the operation at block 606 of FIG. 6, except that the inputs of the first time series model may be different.

At block 708, the computer system/server 12 may update the first future value at the third future time point in the first updated set of the first future values based on the second constraint for the first future value at the third future time point, to obtain an amended first updated set of the first future values. In the example of FIG. 5, the first future value of cost C(t+3) on July could not exceed 4 million dollars, due to e.g., the user's budget. In this example, the 4 million dollars is the second constraint for cost on July, which is referred to as C′(t+3) hereinafter.

In this example, if C(t+3) is higher than C′(t+3), the computer system/server 12 replaces C(t+3) in the first updated set of cost by C′(t+3). Thus, the amended first updated set of cost is obtained, which is used as the current updated set of cost. If C(t+3) is not higher than C′(t+3), the amended first updated set of cost, as the current updated set of cost, is the same as the first updated set of cost. It is to be noted that if there is no constraint for the first variable, the amended first updated set of the first future values is the same as the first updated set of the first future values.

At block 710, the computer system/server 12 forecasts a second updated set of the second future values using the second time series model, based on the amended first updated set of the first future values. The operation at block 710 is similar to the operation at block 610 of FIG. 6, except that the inputs of the second time series model may be different.

The operations at blocks 712-716 is the same as the operation at blocks 612-616 of FIG. 6, the details of which are not repeated here.

As can be seen from the above, the method 400 for goal seeking analysis may optimize the future values of the direct effect and the indirect effect to meet the target value of the target metric. It is a more practical method, compared with an application where only the direct effect is taken into account for time series forecasting.

It is appreciated that the embodiments of the present disclosure may be adapted for other fields. In an example, in the field of construction, the target metric may be construction progress, the direct effect may be the number of workers, and the indirect effect may be salaries of the workers. In another example, in the field of environment protection, the target metric may be a water saving volume, the direct effect may be the number of water-saving facilities, and the indirect effect may be output power of the water-saving facilities. In still another example, in the field of energy saving, the target metric may be the amount of energy saving, the direct effect may be the number of energy saving facilities, and the indirect effect may be the cost of the energy saving facilities.

Under the same inventive concept, another embodiment of the disclosure can provide an apparatus. The apparatus may include one or more processors, a memory coupled to the one or more processors, and a set of computer program instructions stored in the memory and executed by the one or more processors. The set of computer program instructions when executed perform the actions of obtain an initial set of first future values of a first variable at a plurality of future time points; obtain an initial set of second future values of a second variable at the plurality of future time points, wherein the first variable and the second variable are affected mutually; obtain an initial set of third future values of a third variable at the plurality of future time points, wherein the third variable is affected by the second variable; and adjust the first future values, the second future values and the third future values based on a target value of the third variable at a first future time point of the plurality of future time points.

Similarly, under the same inventive concept, another embodiment of the present disclosure can provide a computer program product. The computer program product comprises a computer readable storage medium having program instructions embodied therewith. The program instructions are executable by a processor to obtain an initial set of first future values of a first variable at a plurality of future time points; obtain an initial set of second future values of a second variable at the plurality of future time points, wherein the first variable and the second variable are affected mutually; obtain an initial set of third future values of a third variable at the plurality of future time points, wherein the third variable is affected by the second variable; and adjust the first future values, the second future values and the third future values based on a target value of the third variable at a first future time point of the plurality of future time points.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
obtaining, by one or more processors, an initial set of first future values of a first variable at a plurality of future time points;
obtaining, by one or more processors, an initial set of second future values of a second variable at the plurality of future time points, wherein the first variable affects the second variable, and the second variable affects the first variable;
obtaining, by one or more processors, an initial set of third future values of a third variable at the plurality of future time points, wherein the second variable affects the third variable; and
adjusting, by one or more processors, the first future values, the second future values and the third future values based on a target value of the third variable at a first future time point of the plurality of future time points, wherein adjusting the first future values, the second future values and the third future values is performed by using a first time series model, a second time series model and a third time series model.

2. The method according to claim 1, further comprising:
wherein the first time series model defines that a future value of the first variable is associated with past values of the first variable and the second variable;
wherein the second time series model defines that a future value of the second variable is associated with past values of the first variable and the second variable; and
wherein the third time series model defines that a future value of the third variable is associated with past values of the second variable and the third variable.

3. The method according to claim 1, wherein the adjusting the first future values, the second future values and the third future values comprises:
adjusting iteratively, by one or more processors, the first future values, the second future values and the third future values using the first time series model, the second time series model and the third time series model, until a condition is satisfied; and
outputting, by one or more processors, an adjusted set of the first future values, an adjusted set of the second future values, and an adjusted set of the third future values.

4. The method according to claim 3, wherein the adjusting iteratively the first future values, the second future values and the third future values using the first time series model, the second time series model and the third time series model comprises, in each iteration:
calculating, by one or more processors, a first updated set of the second future values using the third time series model, based on the target value of the third variable at the first future time point;
forecasting, by one or more processors, a first updated set of the first future values using the first time series model, based on the first updated set of the second future values;
forecasting, by one or more processors, a second updated set of the second future values using the second time series model, based on the first updated set of the first future values;
forecasting, by one or more processors, a candidate set of the third future values using the third time series model, based on the second updated set of the second future values; and
determining, by one or more processors, whether the condition is satisfied.

5. The method according to claim 4, wherein a calculation of the first updated set of the second future values is performed in conjunction with an update of the third future values.

6. The method according to claim 3, wherein the adjusting iteratively the first future values, the second future values and the third future values using the first time series model, the second time series model and the third time series model comprises, in each iteration:
calculating, by one or more processors, a first updated set of the second future values using the third time series model, based on the target value of the third variable at the first future time point;
updating, by one or more processors, the second future value at a second future time point in the first updated set of the second future values based on a first constraint for the second future value at the second future time point, to obtain an amended first updated set of the second future values;
forecasting, by one or more processors, a first updated set of the first future values using the first time series model, based on the amended first updated set of the second future values;
updating, by one or more processors, the first future value at a third future time point in the first updated set of the first future values based on a second constraint for the first future value at the third future time point, to obtain an amended first updated set of the first future values;
forecasting, by one or more processors, a second updated set of the second future values using the second time series model, based on the amended first updated set of the first future values;
forecasting, by one or more processors, a candidate set of the third future values using the third time series model, based on the second updated set of the second future values; and
determining, by one or more processors, whether the condition is satisfied.

7. The method according to claim 6, wherein a calculation of the first updated set of the second future values is performed in conjunction with an update of the third future values.

8. The method according to claim 3, wherein the condition comprises one of the following:
a first difference between the target value and an adjusted third future value at the first future time point being lower than a first threshold;
a second difference between the first differences at two adjacent iterations being lower than a second threshold; and
a period of time of the iterations being higher than a third threshold.

9. The method according to claim 2, wherein the obtaining the initial set of first future values of the first variable at the plurality of future time points comprises:
forecasting, by one or more processors, the initial set of first future values of the first variable at the plurality of future time points using the first time series model,
wherein the first future value at a given future time point is forecasted based on N past values of the first variable and those of a second variable immediately before the given future time point, and N is a natural number.

10. The method according to claim 2, wherein the obtaining the initial set of second future values of the second variable at the plurality of future time points comprises:
forecasting, by one or more processors, the initial set of second future values of the second variable at the plurality of future time points using the second time series model,
wherein the second future value at a given future time point is forecasted based on N past values of the first variable and those of the second variable immediately before the given future time point, and N is a natural number.

11. The method according to claim 2, wherein the obtaining the initial set of third future values of the third variable at the plurality of future time points comprises:
forecasting, by one or more processors, the initial set of third future values of the third variable at the plurality of future time points using the third time series model,
wherein the third future value at a given future time point is forecasted using the third time series model, based on N past values of the second variable and those of a third variable immediately before the given future time point, and N is a natural number.

12. An apparatus comprising:
one or more processors;
a memory coupled to the one or more processors;
a set of computer program instructions stored in the memory and configured to cause, when executed by the one or more processors, the apparatus to implement a method comprising:
obtaining an initial set of first future values of a first variable at a plurality of future time points;
obtaining an initial set of second future values of a second variable at the plurality of future time points, wherein the first variable affects the second variable, and the second variable affects the first variable;
obtaining an initial set of third future values of a third variable at the plurality of future time points, wherein the second variable affects the third variable; and
adjusting the first future values, the second future values and the third future values based on a target value of the third variable at a first future time point of the plurality of future time points, wherein adjusting the first future values, the second future values and the third future values is performed by using a first time series model, a second time series model and a third time series model.

13. The apparatus according to claim 12, further comprising:
wherein a first time series model defines that a future value of the first variable is associated with past values of the first variable and the second variable;
wherein a second time series model defines that a future value of the second variable is associated with past values of the first variable and the second variable; and
wherein a third time series model defines that a future value of the third variable is associated with past values of the second variable and the third variable.

14. The apparatus according to claim 12, wherein the adjusting the first future values, the second future values and the third future values comprises:
adjusting iteratively the first future values, the second future values and the third future values using the first time series model, the second time series model and the third time series model, until a condition is satisfied; and
outputting an adjusted set of the first future values, an adjusted set of the second future values, and an adjusted set of the third future values.

15. The apparatus according to claim 14, wherein the adjusting iteratively the first future values, the second future values and the third future values using the first time series model, the second time series model and the third time series model comprises: in each iteration,
calculating a first updated set of the second future values using the third time series model, based on the target value of the third variable at the first future time point;
forecasting a first updated set of the first future values using the first time series model, based on the first updated set of the second future values;
forecasting a second updated set of the second future values using the second time series model, based on the first updated set of the first future values;
forecasting a candidate set of the third future values using the third time series model, based on the second updated set of the second future values; and
determining whether the condition is satisfied.

16. The apparatus according to claim 15, wherein a calculation of the first updated set of the second future values is performed in conjunction with an update of the third future values.

17. The apparatus according to claim 14, wherein the adjusting iteratively the first future values, the second future values and the third future values using the first time series model, the second time series model and the third time series model comprises: in each iteration,
calculating a first updated set of the second future values using the third time series model, based on the target value of the third variable at the first future time point;
updating the second future value at a second future time point in the first updated set of the second future values based on a first constraint for the second future value at the second future time point, to obtain an amended first updated set of the second future values;
forecasting a first updated set of the first future values using the first time series model, based on the amended first updated set of the second future values;
updating the first future value at a third future time point in the first updated set of the first future values based on a second constraint for the first future value at the third future time point, to obtain an amended first updated set of the first future values;
forecasting a second updated set of the second future values using the second time series model, based on the amended first updated set of the first future values;
forecasting a candidate set of the third future values using the third time series model, based on the second updated set of the second future values; and
determining whether the condition is satisfied.

18. The apparatus according to claim 17, wherein a calculation of the first updated set of the second future values is performed in conjunction with an update of the third future values.

19. The apparatus according to claim 14, wherein the condition comprises one of the following:
a first difference between the target value and an adjusted third future value at the first future time point being lower than a first threshold;
a second difference between the first differences at two adjacent iterations being lower than a second threshold; and
a period of time of the iterations being higher than a third threshold.

20. A computer program product comprising a computer readable storage medium having program instructions embodied therewith, wherein the program instructions are executable by one or more processors to implement a method comprising:
obtaining an initial set of first future values of a first variable at a plurality of future time points;
obtaining, by one or more processors, an initial set of second future values of a second variable at the plurality of future time points, wherein the first variable affects the second variable, and the second variable affects the first variable;
obtaining, by one or more processors, an initial set of third future values of a third variable at the plurality of future time points, wherein the second variable affects the third variable; and
adjusting the first future values, the second future values and the third future values based on a target value of the third variable at a first future time point of the plurality of future time points, wherein adjusting the first future values, the second future values and the third future values is performed by using a first time series model, a second time series model and a third time series model.
